(19) United States
(12) Patent Application Publication
(10) Pub. No.: US 2011/0105094 A1
(43) Pub. Date: May 5, 2011

(54) LOCATION INTEGRATION IN SOFTWARE DEFINED RADIO

(75) Inventors: Amer A. Hassan, Kirkland, WA (US); Hui Shen, Sammamish, WA (US); Billy R. Anders, JR., Bothell, WA (US)

(73) Assignee: Microsoft Corporation, Redmond, WA (US)

(21) Appl. No.: 12/608,563

(22) Filed: Oct. 29, 2009

(51) Int. Cl. H04M 3/00; H04W 64/00; H04N 7/16

(52) U.S. Cl. 455/418; 455/456.3; 725/62

(57) ABSTRACT

A computing device having a software defined radio (SDR) wireless network interface is automatically configured to support a wireless service in response to a request from the user to access the service. The computing device may determine the appropriate profile and obtain it by querying a remote database. The query may indicate the computing device's current location, though location information may alternatively be determined by a server coupled to the database. The communication profile is downloaded from the remote database using an existing or available network connection. The software defined radio is configured with the communication profile and is used to access an available wireless service. Content obtained from the wireless service is presented through a user interface of the computing device.

### BACKGROUND

Wireless networks provide a convenient way for users of mobile devices to receive news, entertainment, and communications while on the go. Today's mobile devices primarily rely on hardware specially designed for a particular service provider's wireless network. When traveling, users may find the specialized hardware in their handheld does not work at the location they are visiting. For example, a user may be able to access a wireless service (like mobile TV) through a mobile device while at home, but when traveling out of the country the mobile device does not pick up any stations.

This problem is due in part to the use of incompatible wireless standards in different parts of the world. When a user leaves her provider's service area, her mobile device will lose connection with the provider's wireless network. Though a mobile device may be able to connect to another network using the same technology or a technology compatible with the one for which the mobile device is configured, such a connection may not always be possible. If a wireless service offered in a region where the wireless device is located uses a different technology than the user's mobile device, the device will not be able to connect to the services.

Though some mobile devices have been developed that support multiple wireless protocols, hardware implementations generally require different components for each technology. An alternative approach to multiple hardware implementations is to use a software defined radio (SDR). In a software defined radio at least some of the transceiver functions conventionally performed in hardware are performed using processors executing software instructions. Some devices using software defined radio are tunable, but this may not always be adequate.

### SUMMARY

A mobile computing device may be automatically configured to support a wireless service by configuring a software defined radio (SDR) to support a technology used to provide that service in the region where the mobile device is located. A radio profile may provide information that can be used to configure the SDR to operate according to a wireless technology used by the wireless service. The radio profile may be identified and obtained in response to a user request for a wireless service such that the experience of the user of the mobile computing device is enhanced. The user may have a consistent experience connecting to the wireless service regardless of the location of the mobile computing device or the underlying technology used for the service.

The appropriate radio profile may be selected based on a determined location for the mobile device. The current location may be determined locally at the computing device or by another device remote to the computing device.

Radio profiles may be stored locally or maintained in a remote database. Using a remote database may reduce the burden on the computing device and provide a reliable central repository from which the latest service region information and most up-to-date radio profiles may be obtained. Information collected to identify the radio profile may be submitted as a query to a chosen database. For example, the database may be queried with information identifying the desired wireless service and the location of the computing device. The database may use this information to identify the radio profile and return it to the computing device.

Once a radio profile has been obtained at the computing device may use it to configure the SDR to access the content from the wireless service. A local copy of the radio profile may be stored along with information which may be used to identify when it should be used. For example, information about the service region and the wireless service may be saved in association with the radio profile. Storing local copies of the radio profiles reduces the likelihood the computing device will become “stranded” without the ability to connect to the remote database to obtain the radio profile.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of an operating environment of a computing device according to some embodiments of the invention;

FIG. 2 is a flow chart of a method for configuring a computing device to receive content according to some embodiments of the invention;

FIG. 3 is a flow chart of another method for configuring a computing device to receive content;

FIG. 4 illustrates a user interface for selecting a service type according to some embodiments of the invention;

FIG. 5 illustrates a user interface displayed during configuration of a selected service on the computing device according to some embodiments of the invention;

FIG. 6 illustrates a user interface providing available options for a selected service; and

FIG. 7 illustrates a user interface for presenting content according to some embodiments of the invention.

### DETAILED DESCRIPTION

Being able to use a wireless device regardless of location contributes to providing a great user experience, particularly for users of mobile devices. The proliferation of wireless standards has made it difficult for users to have such a seamless experience. One wireless computing device may work perfectly with a wireless service in one country, but in another, which uses a different wireless standard, the device may be unable to connect to the wireless service at all. The user is forced to live without the wireless service, or perhaps have multiple wireless devices, each for a particular area. Even devices that support multiple wireless standards may pose a burden on the user to properly configure the device in each service area.

The inventors have recognized and appreciated that a wireless computing device that automatically configures itself to access available wireless services desired by the user would greatly improve the user's experience. Such a computing device may be implemented with a software defined radio that can be configured using a radio profile or may contain components that may be configured based on some other form of communication profile. By identifying and obtaining a radio profile to configure the SDR for a wireless technology used by a wireless service desired by the user in the current location, that service can be provided. The inventors have recognized and appreciated ways in which the correct radio profile may be identified and installed automatically, greatly enhancing the user experience. With such a computing device, the switch between wireless technologies becomes a seamless transition which can be made with little or no knowledge or intervention by the user.

In some embodiments, information related to the current geographic location of the computing device may be used to identify radio profiles that may be used to connect to local wireless services. Direct methods, such as the global positioning system (GPS), may be used to identify the computing device's current location. Though other, indirect, methods may alternatively or additionally be used. For example, the IP address assigned to the computing device for an Internet connection provides a strong indication of the devices location.

Whatever information is collected to use as a basis for identifying the location may be used in a database query. The database may be local to the computing device or a remote database accessed via another connection. A successful query may identify the radio profile to use for accessing the wireless service desired by the user in a current location of the computing device. That radio profile may then be used to configure the wireless interface of the computing device. The computing device, now configured with the radio profile for the desired wireless service, may begin exchanging content and information through the wireless service and sharing it with the user.

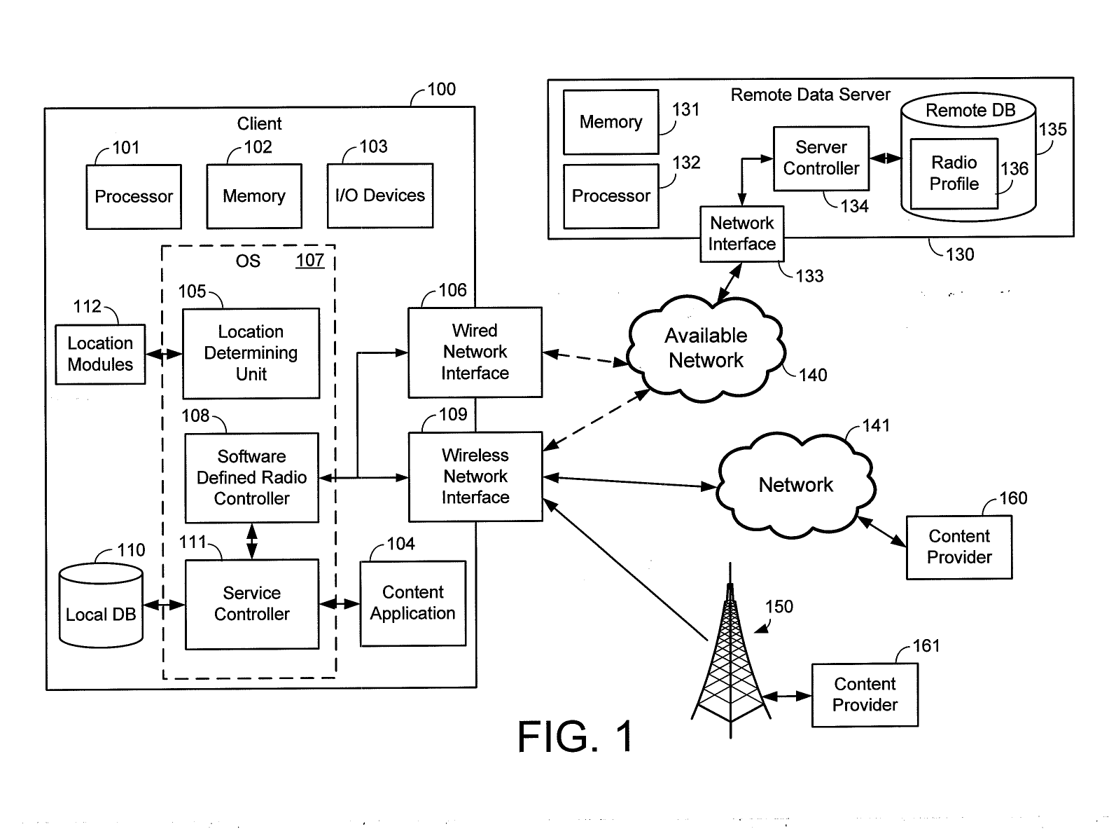

FIG. 1 shows an exemplary environment in which a client computing device 100 is configured to access content over a wireless network. Computing device 100 may be any suitable type of computing device. Though, in the embodiment illustrated in FIG. 1, computing device 100 is a mobile computing device.

In some embodiments, the computing device 100 comprises a processor 101, memory 102, input/output (I/O) devices 103, a wired interface 106, and a wireless interface 109.

Processor 101 may be a processor as known in the art or any suitable processing device. For example and not limitation, processor 101 may be a central processing unit (CPU), digital signal processor (DSP), controller, addressable controller, general or special purpose microprocessor, microcontroller, addressable microprocessor, programmable processor, programmable controller, dedicated processor, dedicated controller, or any other suitable processing device.

Memory 102 may store data and/or software modules containing computer-executable instructions that when executed by processor 101 perform a desired function. Memory 102 may be a computer-readable storage medium as is known in the art or any suitable type of computer-readable storage medium. For example and not limitation, memory 102 may be RAM, a nanotechnology-based memory, one or more floppy discs, compact discs, optical discs, volatile and non-volatile memory devices, magnetic tapes, flash memories, hard disk drive, circuit configurations in Field Programmable Gate Arrays, other semiconductor devices, or other tangible computer storage medium or combination thereof.

I/O devices 103 may include any type of I/O device for providing and/or receiving information including I/O devices as known in the art. I/O devices 103 may include, for example and not limitation, a keypad such as a keyboard, pointing device such as a mouse or trackball, microphone, joystick, touch screen display, display, speaker, or a combination thereof.

Wired network interface 106 may be any suitable type of interface for connecting to a network over a wire (e.g., Ethernet, fiber-optic, coaxial). For example and not limitation, wired network interface 106 may support an Ethernet network connection.

Wireless interface 109 may contain hardware components, such as a transmitter and receiver to receive and transmit information wirelessly to and from computing device 100. Wireless interface 109 is at least partially controlled with a software defined radio controller 108. In combination, wireless interface 109 and software defined radio controller 108 implement a software defined radio. Functions of the software defined radio may be allocated between wireless interface 109 and software defined radio controller 108 in any suitable manner.

In the embodiment illustrated, software defined radio controller 108 uses a radio profile to configure software defined radio for a wireless communications protocol. Particularly, controller 108 interfaces with the hardware of wireless interface 109 to act as a wireless receiver or transmitter of a particular wireless communications protocol. The radio profile may be in any suitable form to achieve the desired configuration for the software defined radio. In some embodiments, the radio profile includes configuration information to configure the hardware and/or software components of the SDR to implement the protocol. In some embodiments, the radio profiles include computer-executable modules that implement functions of controller 108. In another embodiment, controller 108 is set up with the configuration information from the radio profile.

Regardless of the format of the radio profile, once it is applied, the software defined radio, including wireless interface 109 and software defined radio controller 108, may be configured to support any suitable wireless communications protocol. For example, wireless interface 109 may be configured to support any standard or proprietary communications protocol, such as those for wireless personal area network (WPAN), wireless local area network (WLAN), wireless local area network (WLAN), wireless metropolitan area networks (wireless MAN), wireless wide area network (WWAN), or other types of networks. Wireless interface 109 may, for example and not limitation, be configured by software defined radio controller 108 for use with any of IEEE 802.11, Wi-Fi, ultra-wide band (UWB) technologies, Bluetooth, Wireless USB, WiMedia, WiMax, Wireless 1394, Code Division Multiple Access (CDMA), Time Division Multiple Access (TDMA), Global System for Mobilization (GSM), Cellular Digital Packet Data (GPRS), or General Packet Radio Service (GPRS).

Computing device 100 may include a number of modules configured to perform a specific function. In the illustrated embodiment, the computing device 100 includes an operating system 107 (OS), a location determining unit 105, a software defined radio controller 108, a service controller 108, location modules 112, and a content application 104. Modules may be implemented in hardware, software, or any suitable combination thereof. In some embodiments, a module may comprise computer-executable instructions. The instructions may be stored in memory 102 and executed by processor 101.

OS 107 may provide functions for content application 104 executing on computing device 100, for example, through function calls from application 104. In some embodiments, OS 107 includes modules to automatically configure network interface 109 when a user wants to receive content from a wireless service. Location determining unit 105, service controller 111, and software defined radio controller 108 may be implemented as modules of OS 107.

OS 107 may manage the activities and sharing of resources of wireless device 107. OS 107 may provide various functions and manage computing device 100 through various components. These components may include, for example and not limitation, dynamically linked libraries (e.g., a dynamic-link library), application programming interfaces (APIs), component object models (COMs), globally unique identifiers, registry keys, or any uniquely identifiable part of OS 107. Some components of OS 107 may also generate packets to be transmitted over a network.

In some embodiments, one or more content applications, such as content application 104, present content from a wireless service to a user. For example, a content application may emulate a television, obtaining video data from a broadcast TV station and presenting that content to a user. Each content application may be associated with one or more wireless services. For example, different content applications may be associated with a televisions service, a radio service and an Internet access service. When a user selects content application 104, the SDR may be automatically configured by service controller 111 to support the wireless protocol used by an associated wireless service.

In some embodiments, service controller 111 is used to manage a seamless process of identifying a radio profile for use with SDR controller 108 and network interface 109 when a user has selected a wireless service. Service controller 111 may identify and locate the radio profile in any suitable way. In some embodiments, a query is built by service controller 111 and submitted to a local database 111 and/or a remote database 135 on a remote data server 130. For example, service controller 111 may first query the local database to identify an appropriate profile and, if not found, may then query the remote database. In other embodiments, service controller 111 may query the remote database to obtain an identification of the appropriate profile and then obtain that profile from the local database. The desired radio profile may be returned in response to the query. Regardless of how service controller 111 obtains the radio profile, service controller 111 configures SDR controller 108 and/or network interface 109 with the radio profile to implement an SDR supporting the wireless technology used by the desired service.

Though a device with an SDR is used as an example herein, it should be appreciated that service controller 111 alternatively or additionally may identify other types of communication profiles for configuring computing device 100. A communication profile, for example, may configure or provide software for computing device 100 to communicate with a desired service. As a specific example, a communication profile may be used to configure the computing device to extract content from a signal received through the wireless network interface. In some embodiments, a communication profile also includes information for configuring hardware of computing device 100. A communication profile may used to configure computing device 100 regardless of whether computing device 100 includes of software defined radio. When computing device 100 includes a software defined radio, the communication profile may include a radio profile for configuring the SDR.

A communication profile may be identified, obtained, and used in ways similar to those described for a radio profile. For example, service controller 111 may identify a communication profile using the location of the computing device. Though, a communication profile may be identified in any suitable way.

In some embodiments where the location of computing device 100 is used in identifying the radio profile, computing device 100 may include a location determining unit 105. Location determining unit 105 is used to make a local determination of the current location of computing device 100. It should be appreciated that the current location need only be accurate enough for the purpose of identifying a service region containing computing device 100. In some circumstance, service regions are defined by political boundaries, which rarely encompass less than tens or hundreds of square miles. Accordingly, the ability to determine the current location within a few miles may be sufficiently accurate. In many cases being able to identify a city, metropolitan area, or even a country in which computing device 100 is located may be sufficient for the purpose of identifying a service region.

Location determining unit 105 may use one or more location modules 112 to determine the current location of computing device 100. Several examples of location modules are now provided. These examples are illustrative and not intended to be exhaustive. The current location may be determined in any suitable way.

Location modules 112 may include a satellite positioning module which utilizes a global navigation satellite service (GNSS) to determine the current location of computing device 100 from navigational satellites. Examples of GNSSs include the United States' Global Positioning Service (GPS), the European Union's Galileo positioning system (scheduled for 1012), the Russian's GLONASS system, and China's Compass system. Though, any suitable GNSS may be supported.

Location modules 112 may include a network location module which determines the current location from a “network location” of computing device 100. The current location of computing device 100 may be inferred based on the proximity of the computing device on the network to a network computing device having a known location. For example, when computing device 100 is connected to the Internet, the IP address assigned to the device, or network address translation (NAT) device through which the Internet is accessed, may be used to identify the current location of the device. This may be done, for example, using a “WHOIS” service. Though, network location may be used to infer physical location in any suitable way. The computing device may be connected to a network computing device having a known location via a wired network connection, a wireless network connection, or any suitable combination of wired and wireless network connections.

Location modules 112 may include a beacon signal analyzing module which analyzes wireless beacons to determine the current location of computing device 100. How the beacon represents information that may be used to determine the current location may depends on the source of the beacon signal. For example, public land mobile networks (PLMN) each have a unique identifier known as Location Area Identity (LAI). The LAI includes a mobile country code (MCC) which is standardized. For example, one MCC used for the United States is “310”. As another example, IEEE 802.11d beacon signals include a country code. Because compliance with 802.11d is voluntary and the country code is set by users, the beacon signal analyzing service may be configured to test for agreement between multiple beacon signals from several networks before relying on the country code indicated by IEEE 802.11d beacons.

Location modules 112 may include a cellular base-station module which uses signals from cellular communications towers to determine the current location of computing device 100. For example, the cellular base-station module may use the principle of triangulation to identify the current location of computing device 100.

Location modules 112 may include a user entry module which prompts the user to designate the current location. The user entry module may prompt the user to provide the current location in any suitable way. For example, by displaying a map and having the user indicate her location on the map using a pointing device. In some embodiments, successive designations may be used by zooming the map in on an area near the previous designation. In some embodiments, the user simply enters, for example, the name of a city or country which is the current location. Though, the user may be prompted by the user entry service in any suitable way.

Because location determining unit 105 may have access to multiple location modules 112 from which to determine the current location, one or more techniques may be used to fuse information from multiple location modules. In some embodiments, priorities may be assigned to the available modules. The priority for each location module may be automatically assigned or user configured. Though, the priority may be determined in any suitable way. In some embodiments, priority is assigned to each location module based on the accuracy with which it determines the current location. Location determining unit 105 may attempt to obtain the current location from location modules 112 in the order of their priority. For example, location determining unit 105 may attempt to obtain the current location using the location module having the highest priority. If the highest priority service fails to provide the currently location, an attempt is made using the next highest priority location service. This continues until the current location is obtained or, for example, a user is prompted to enter the current location. In some embodiments, the current location may be determined by allowing each service to vote for the current location of the device. The votes may be weighted based on the priority of the respective service and the current location selected as the location with the highest vote. In another embodiment, all or some of the location services are asked to report the current location. The current location may be chosen as the current location identified by the first location service to respond. Though, the current location of computing device 100 may be determined in any suitable way. In some embodiments, the user entry module has a lowest priority among all location services to avoid inconvenience and burden to the user.

In some embodiments, each location module returns the current location in a standard format. For example, the current location may be specified by latitude and longitude coordinates, country, postal code, city, state, province, county, or any suitable way or combination of ways.

Computing device 100 may be configured to exchange information with remote data server 130. Remote data server 130 may be accessed through a wired or wireless connection to network 140. In the embodiment illustrated, server 130 has a network interface 133 which is also connected to network 140. Network interface 133 may be any suitable wired or wireless interface for connecting to network 140. In some embodiments, server 130 provides information to computing device 100 which may be used to identify a radio profile for accessing the desired wireless service. For example, server 130 may be a WHOIS service that can identify a location based on the IP address of computing device 100 on network 140.

In some embodiments, server 130 is configured to receive queries from computing device 100. The queries may include any suitable information for identifying the desired radio profile. For example, the query may include information such as the wireless service desired, the current location of computing device 100, and information about computing device 100, such as an IP address or hardware capabilities. Though, in some embodiments, location information may be determined by server 130 instead of or in addition to the information in the query. For example, server controller may determine the location of computing device 100 based on its IP address on network 140.

Regardless of the information in the query, server controller 134 may submit the query to database 135. Database 135 may contain multiple types of information. For example, it may contain information identifying appropriate wireless technologies used for multiple types of services in multiple locations. It may also contain radio profiles that configure an SDR in computing devices with various hardware configurations. Though, it should be appreciated that information identifying the appropriate profile may be stored separately from the profiles, such that database may store information that can be used to obtain an appropriate radio profile.

Though, in the embodiment illustrated, in response to a successful query, database 135 may return one or more radio profiles 136 to server controller 134. Server controller 134 may then instruct network interface 133 to forward radio profiles 136 to computing device 100 over network 140.

Remote data server 130 may be implemented using any suitable hardware and software components. In the embodiment illustrated server 130 includes processor 132. Processor 132 may be implemented in any suitable way. For example, processor 132 may be implemented in ways similar to those described above for implementing processor 101.

Remote data server 130 includes memory 131. In some embodiments, memory 131 may be used to store remote database 135. Memory 131 may be implemented in any suitable way. For example, memory 131 may be implemented in ways similar to those described above for implementing memory 102.

Server controller 134 may be implemented in any suitable combination of hardware and software. In embodiments in which server controller 134 is at least partially implemented in software, the software instructions for server controller 134 may be executed by processor 132. Though, server controller 134 may be implemented in any suitable way.

Once computing device 100 has been configured with the radio profile to access the wireless service selected by the user, a connection to the wireless service may be formed and transmission or reception of content may begin. For the purposes of illustration, in FIG. 1 a broadcast station 105 which broadcasts content from content provider 161 is shown. Content provider 161 may be providing radio, television, or any suitable type of media or multimedia content. In some embodiments, content provider 161 may also provide information customized for the user. For example, a content provider may provide an advertisement related to the wireless service's content and location of the user. Received content may be provided to content application 104 for presentation to the user of computing device 100. As another example, computing device 100 may be configured to receive the wireless service selected by the user from content provider 160 through a network 141.

Networks 140 and 141 may be any suitable type of network. For example, network 140 may be a public network such as the Internet or a private network, such as a corporate network. Though shown separately, in some embodiments networks 140 and 141 are the same network.

Though only one computing device 100 is illustrated in FIG. 1, it should be appreciated that any suitable number of computing devices may coexist in the illustrated environment. Similarly, while only one remote server 150 is illustrated, any number of servers for providing radio profiles may exist in the environments.

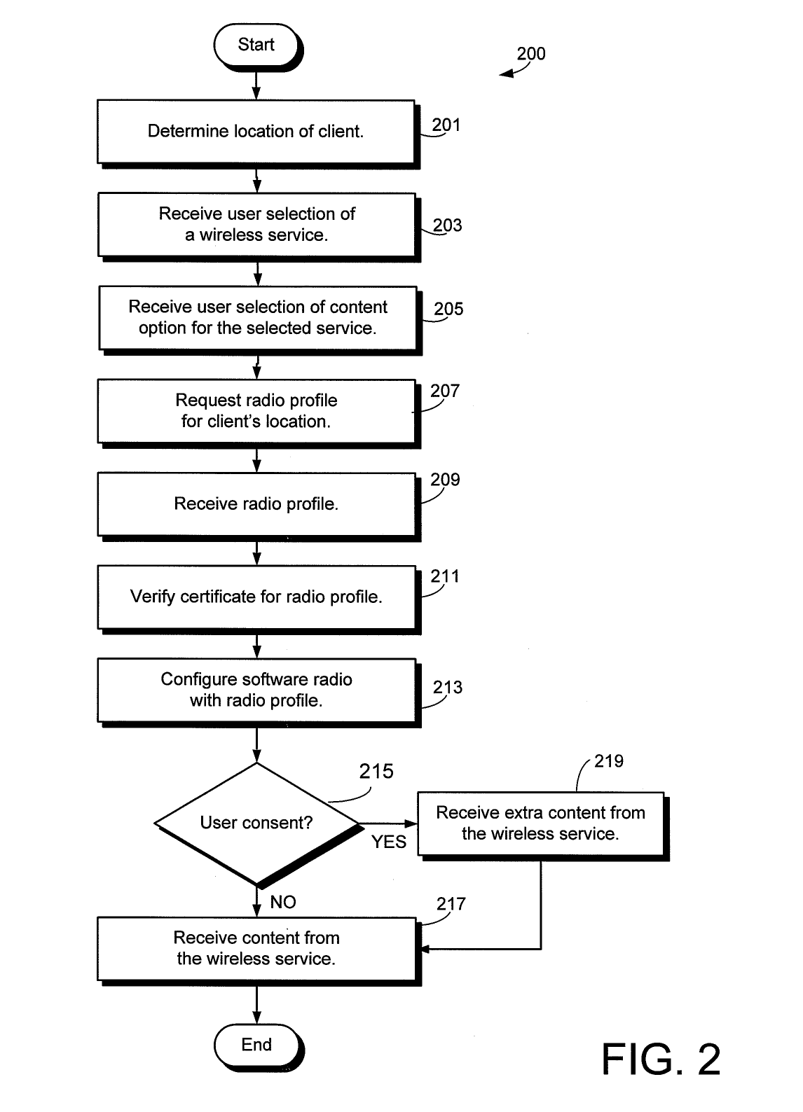

Turning now to FIG. 2, a method 200 for configuring a client computing device, such as computing device 100 (FIG. 1), to receive content wirelessly is described. The method shown in FIG. 2 may be initiated in response to any suitable event. For example, it may be initiated in response to a user request for a wireless service. Also, the method of FIG. 2 may be performed under control of any suitable component or components. For example, the process may be controlled by programming within service controller 111.

At step 201, the current location of the client computing device is determined. The current location may be determined in any suitable way. In some embodiments, the current location may be determined by a location determining unit using one or more location modules. For example, a satellite positioning module, a cellular base-station module, a beacon signal analyzing module, a network location module, or user entry may be used to determine the current location.

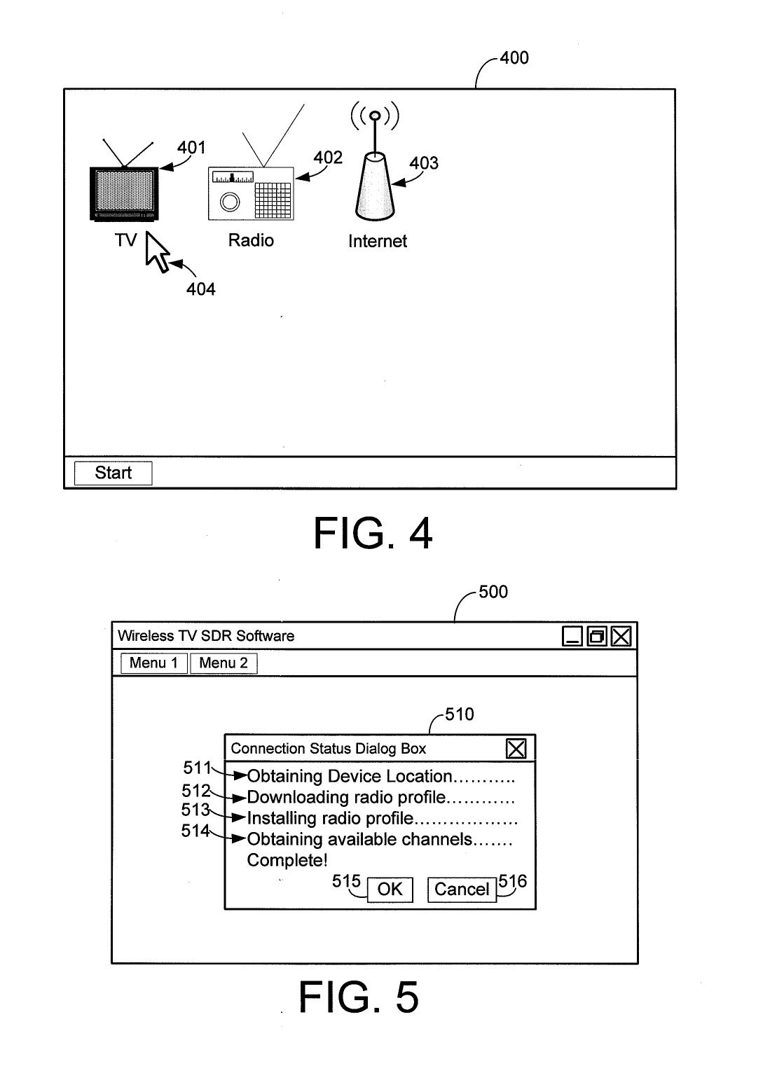

At step 203, a user selection of a wireless service type is received. In some embodiments, the user selection is received through a user interface provided on the client computing device. In some embodiments, such as the example illustrated in FIG. 4, each type of wireless service is represented by an icon on a display of the computing device. The user may select one of the icons corresponding to the desired wireless service. Though, the user selection of the type of wireless service may be made in any suitable way. In some embodiments, the user selects from a group of services including at least one of a television service, a radio service, and an Internet access service. Though, any type of wireless service may be available for selection by the user.

At step 205, content options for the selected wireless service are presented to the user for selection. Content options may be presented in any suitable way. For example, if the service selected at step 203 is a television service, the content options may include a list of channels or a list of programs that are available through the television service. At step 205, a user selection of a channels or program is received. For example, the user may have selected a radio service at step 203. Accordingly, at step 205, a user selection of a radio station to listen to may be received. As another example, if the user selected an Internet access service at step 203, at step 205 a web address the user wishes to browse to may be entered through a web browser presented to the user.

Information to present content options may be obtained in any suitable way. The information, for example, may be obtained from server 130 or other suitable centralized repository of information. In some embodiments, the content options are determined by an application for accessing the selected wireless service. Alternatively or additionally, once an SDR is configured to receive content over a service, it may monitor communications associated with that service to determine content options. In some embodiments, content options may be obtained from a wireless signal which may be received using a wireless interface. For example, the content options may be transmitted from a remote server. In some embodiments, content options are determined after connecting to the wireless service. Accordingly, it should be appreciated that the steps of method 200 may be performed in a different order than illustrated and a content selection may be made after a radio profile is received and applied.

At step 207, a radio profile corresponding to the current location of the computing device is requested. In some embodiments, the radio profile is requested from a remote server over an existing or available network connection such as a wired or wireless network connection. In some embodiments, a local database is checked to determine if a radio profile for the wireless service selected by the user at the current location is available. If the radio profile is available in a local database, the method may further check whether the profile has expired. If the radio profile has expired, a request may be sent to the remote server for the latest radio profile or a patch to update the expired radio profile to the latest version. In some embodiments the request is made by another device on behalf of the computing device.

The request for the radio profile may include any suitable information for identifying the radio profile. The request may include, for example, an express identification of the profile or may indirectly identify the profile by indicating the desired wireless service and the location of the computing device.

When the request is being made to a remote data server for which a connection currently exists, in some embodiments, the request is for all radio profiles which may be used to access wireless services for which the user may wish to connect that are available at the current location. Obtaining multiple profiles may be useful in avoiding a situation where the computing device is stranded and cannot connect to any wireless services.

At step 209, the radio profile is received at the client computing device. The radio profile may be received over a current network connection from the remote server. In embodiments where the radio profile is available from the local database, the radio profile is received from the local database at step 209. In some embodiments, the computing device is connected to another device that the user has and the radio profile is transferred from the other device. For example, a user may transfer a radio profile from a cellular phone to another handheld.

In some embodiments, the radio profile received at step 209 may be certified. As used herein, certification refers to a mechanism for authenticating the radio profile. In particular, the certificate may be provided to ensure that the radio profile is genuine and has not been tampered with. At step 211, a certificate of the radio profile is verified. Any suitable method of validating the certificate for the radio profile may be used. For example, a public encryption key may be used to decrypt the radio profile verifying that the radio profile is authentic. In another embodiment, a certificate issued from a reliable certificate authority is used to authenticate the radio profile.

In some embodiments, step 211 is optionally performed. For example, the client computing device may trust radio profiles stored in the local database. As another example, the server from which the profile was acquired may be trusted by the client computing device.

If the certificate cannot be verified at step 211, method 200 may be aborted or an attempt may be made to acquire the radio profile from a different source. For example, a different remote database may be used.

If the certificate was verified at step 211 or if verification was not performed, the method continues to step 213. At step 213, the software radio of the client computing device is configured with the radio profile. In some embodiments, the radio profile comprises executable code that, when executed by a processor on the client computing device, controls the radio hardware to operate according to a wireless standard. In some other embodiments, a software defined radio controller configures the software defined radio in accordance with the radio profile. For example, the radio profile may contain data specifying settings or operating parameters. The data is translated into hardware and/or software settings which an SDR controller may use to operate the radio according to the wireless standard.

At step 215, a determination may be made as to whether user consent to receive information other than requested content has been provided. In some embodiments, the client device prompts a user through a user interface of the client device to consent to receiving extra content, such as advertisements, in connection with content for the selected service. Such advertisements may be related to the content provided from the service or may be related to the location of the computing device.

If it is determined at step 215 that the user has not provided consent, method 200 continues to step 217. At step 217, content is received at the client's device through the wireless interface as configured by the radio profile. The received content is presented to the client using an output device suitable for the type of content being received. Though, content received at step 217 does not contain extra materials, such as advertising. For example, visual content may be displayed on a display portion of the computing device, while audio content may be reproduced by a sound reproduction system.

If the user did provide consent at step 215, the method proceeds to step 219. At step 219, the extra content the user consented to is provided. As discussed above, the extra content may include information such as advertisements. The extra content may be selected based on the content provided at step 217 and the location of the computing device.

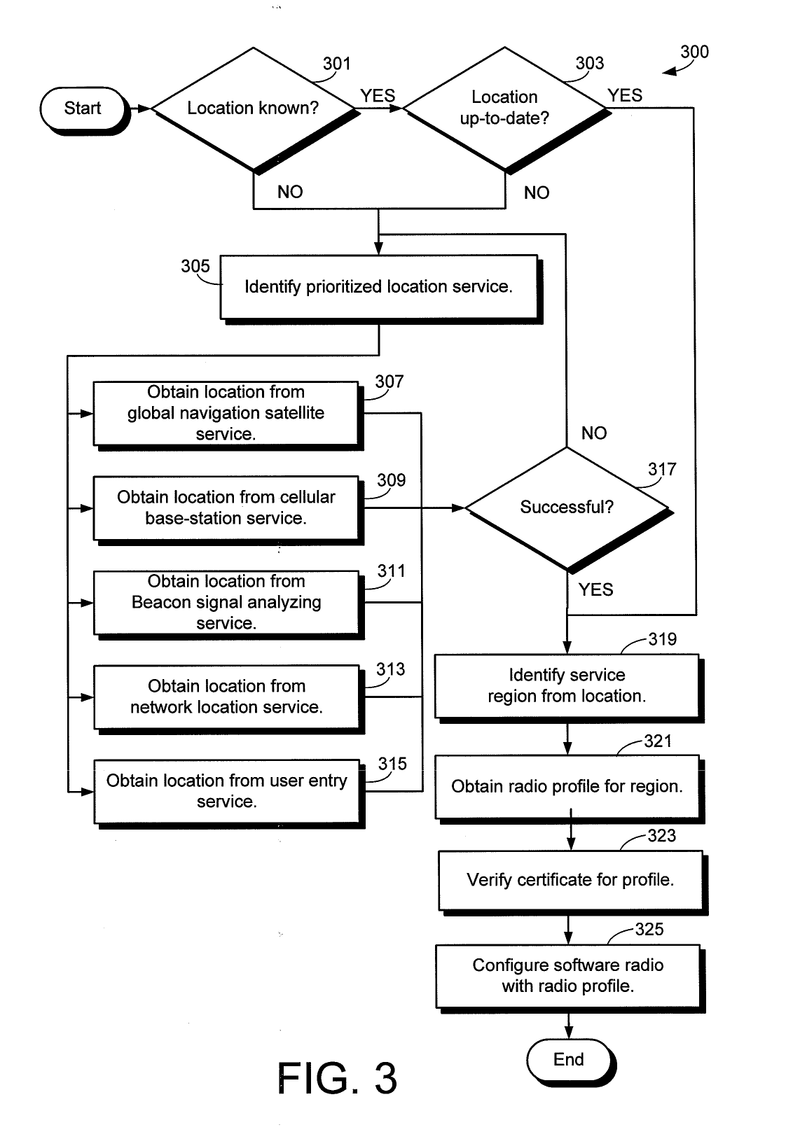

Turning now to FIG. 3, a flow diagram of a method 300 for acquiring a radio profile and configuring a computing device with the radio profile to receive desired content is shown.

At step 301, a determination is made as to whether the current location of client device is known. For example, the current location may have been previously acquired and stored in a memory of the computing device. If the current location is known, the method continues to step 303 where it is determined whether the current location is up-to-date. Determining whether the current location is up-to-date may be done in any suitable way. For example, the elapsed time since acquisition of the current location may be compared to a predetermined expiration time. In another embodiment, the user may simply be asked if the current location is correct.

If the current location is up-to-date, the method continues to step 319. If, however, the current location is either unknown or not up-to-date, the method continues to step 305.

At step 305, a prioritized location service is identified. The computing device may have access to multiple location modules, each of which may be used to provide an indication of the current location of the computing device. Each location module may have an associated priority. At step 305, the location module having the highest priority is identified. An example set of location modules in an example order of priority, from highest to lowest, might be a satellite positioning module, a cellular base-station module, a network location module, a beacon signal analyzing module, and a user entry module. Depending on the selection at step 305, the method 300 continues to one of steps 307, 309, 311, 313, or 315. Though, in some embodiments, two or more of steps 307, 309, 311, 313, or 315 and the location information generated during those steps may be fused to make a location determination.

If it is determined at step 305 that a satellite positioning module has the highest priority, the method continues to step 307. At step 307, the current location of the computing device is determined using the satellite positioning module. For example, GPS may be used to determine the current location.

If it is determined at step 305 that a cellular base-station module has the highest priority, the method continues to step 309. At step 309, the current location of the computing device is determined using the cellular base-station module. In some embodiments, the cellular base-station service uses triangulation to determine the current location.

If it is determined at step 305 that a beacon signal analyzing module has the highest priority, the method continues to step 311. At step 311, the current location of the computing device is determined using the beacon signal analyzing module. In some embodiments, the beacon signal analyzing service detects a country code in an IEEE 802.11d beacon signal. As another example, the beacon signal analyzing service may detect the country code from the Location Area Identity broadcast by a public land mobile network. In some embodiments, at step 311 multiple network beacons are analyzed to further validate the country code.

If it is determined at step 305 that a network location module has the highest priority, the method continues to step 313. At step 309, the current location of the computing device is determined using the network location module. In some embodiments, the network location service identifies the current location using a WHOIS look-up of an Internet IP address associated with the computing device.

If it is determined at step 305 that a user entry module has the highest priority, the method continues to step 315. At step 309, the current location of the computing device is determined using the user entry module. In some embodiments, the user is prompt through a user interface of the computing device to enter the current location. Though any suitable method of prompting the user for the current location may be used.

Regardless of which of steps 307-315 are used in attempting to identify the current location, method 300 continues to step 317. At step 317, the method determines whether the current location was obtained. If the current location was not obtained, the method returns to step 305 where the next prioritized location module is identified. The previously-identified location module used may be discounted or its priority lowered in order to select a different service at step 305. The method continues looping through steps 305-317 until it is determined at step 317 that the current location was successfully obtained.

Once the current location has been successfully obtained (or the current location was both known and non-expired at step 303), the method continues to step 319 where one or more service regions are determined from the current location. In some embodiments, each service region identified corresponds to a different type of wireless service. For example, the service regions associated with wireless television services may be different than the service regions for radio services or Internet access services. The step of identifying a service region may be limited to identifying service regions for wireless services of interest to the client computing device. For example, service regions may only be identified for services for which the user of the computing device has a subscription or to which the user is currently requesting access.

In some embodiments, the service regions are identified by the client computing device at step 319. Though, because service regions may be subject to frequent changes, the current location information may be provided to a remote data server which determines the service regions from the current location. Thus, the client device may avoid storing a map of the service regions.

Regardless of how the service region is obtained from the current location, the method continues to step 321 where a radio profile for the service region is obtained. The radio profile may be obtained from a local database or from a remote server. Radio profiles may be obtained at step 321 for all services available in the identified service regions, or limited to services of interested to the client computing device. In some embodiments, the radio profile is specific to both the wireless service being provided and the type of software radio at the client device. Though, in some embodiments, the radio profile is particular to only the wireless service used in the service region.

At step 323, the radio profile is verified. Verification may include authenticating a certificate associated with the radio profile. In some embodiments, the radio profile may be encrypted and at step 323, the radio profile is decrypted using an appropriate key. Though, verification of the radio profile may be performed in any suitable way. In some embodiments, step 323 is optional.

Once the profile has been verified (if verification is to be performed), at step 325 the software defined radio of the wireless network interface is configured using the radio profile. The computing device may then begin receiving content and presenting it to the user.

While methods 200 and 300 have been described with respect to a radio profile, it should be appreciated that these methods may be used to obtain and configure the computing device using other types of communication profiles. A communication profile is a profile for configuring the computing device to communicate with a desired service. A communication profile may or may not include a radio profile.

When methods 200 or 300 are used with respect to a communication profile, at steps 213 and 325 of methods 200 and 300, respectively, the methods may configure the computing device with the communication profile in any suitable way. When the computing device includes a software defined radio, the communication profile may be used to configure the SDR, for example, using a radio profile included with the communication profile.

FIGS. 4-7 illustrate an example output of a display portion of a user interface on the portable computing device according to some embodiments. The series of figures illustrate a sequence that a user may experience to receive desired content on the computing device.

FIG. 4 illustrates a window 400 displayed on a display portion of a computing device. Window 400 is an integrated service manager. In the example illustrated, the service manager manages three wireless services. Specifically, the wireless services available in this example are represented by icons including a television service icon 401, a radio service icon 402, and an Internet access service icon 403. Other embodiments may have fewer or greater wireless services available. The wireless services may be of any suitable kind. In the example shown, the user selects the TV service by activating an input device, such as by using a mouse to positioning cursor 404 over TV service icon 401 and pressing an appropriate button on the mouse (e.g., a mouse click). After selecting TV service icon 401 a window 500 may be displayed on the display of the computing device providing an interface for the TV service with the user (FIG. 5). Window 500 represents a display portion of a user interface of a content application for receiving content from a wireless TV service. In some embodiments, the user is prompted for consent. Though, consent may be obtained at an alternative time in any suitable way. Consent may be required to access the television service, have customized content such as advertisements presented, or to obtain authorization to charge the user for the service or to obtain charge information. If the user does not consent, window 500 may be closed, or access to content may be limited in some way.

Selection of a service may trigger the computing device to automatically configure itself to obtain content from such a service, using techniques as described above. Accordingly, a connection status dialog box 510 may be opened within window 500 to present the status of accessing the TV service to the user. In this example, the status of a sequence of steps are displayed to the user. Line 511 indicates to the user that the computing device is obtaining the current location. Once the current location has been obtained, line 512 may be displayed indicating that the radio profile is being downloaded. Once the radio profile for the TV service has been obtained, line 513 may be displayed indicating that the radio profile is being used to configure the software define radio. Once the radio profile has been configured a wireless connection is made to the wireless TV service and information such as a channel guide may be downloaded. The user is then informed that setup is complete.

At any time the user may chose to abort the process by selecting cancel button 516. The user may also be asked to acknowledge status dialog box 510 by selecting OK button 515 once setup is complete.

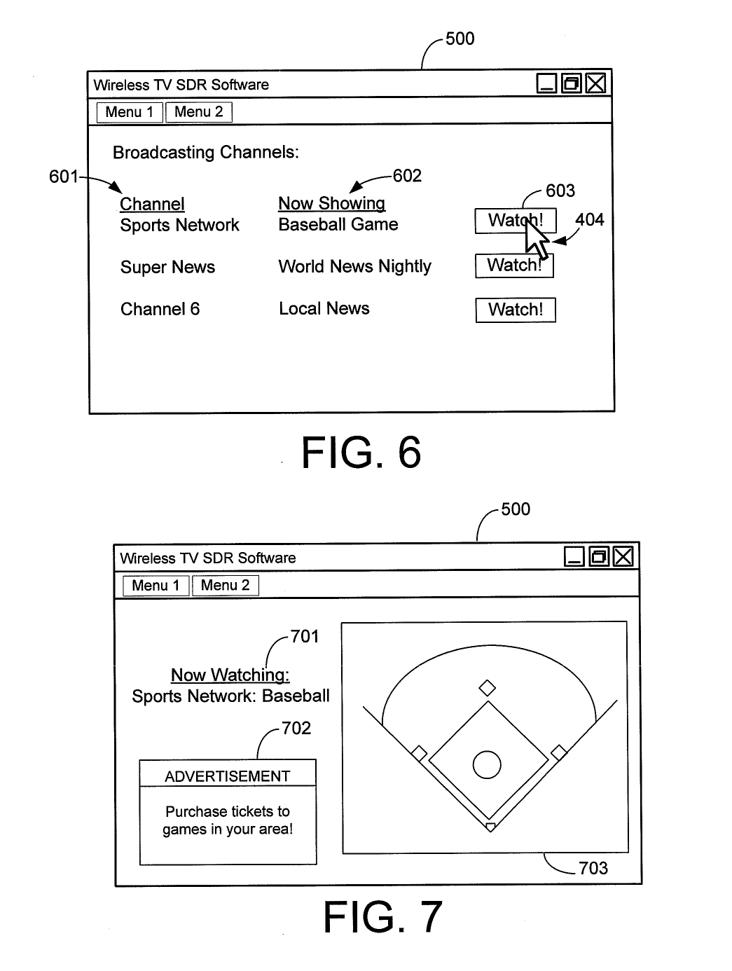

Assuming setup completes successfully, a guide may be displayed in window 500 as shown in FIG. 6. The guide may include information on available content options for the selected service. The guide information may be received from the wireless service, a server connected through a network connection, or in any suitable way. For example, the software defined radio may be configured to receive a stream of data containing the guide from the wireless service. Here the guide includes a list of available channels 601 and a list of the programs 602 currently being broadcast on the respective channels. Though, the guide may be presented in any suitable way. For the purposes of this example, assume the user positions cursor 404 over a button 603 and clicks a button indicating the user's choice to watch the baseball game on the “Sports Network” channel. In some embodiments, the software defined radio may be reconfigured or “tuned” to receive content from the selected channel.

The window 500 is now configured to receive content from the Sports Network Channel. The video images of the baseball game are displayed in a sub-window 703. Audio channels for the program may be played through speakers on the computing device. In some embodiments, information 701 identifying the current channel and program may be identified for the convenience of the user. Additionally an advertisement 702 may be displayed within window 400. The advertisement may be customized based on the location of the user and the content the user requested. For example, advertisement 702 reads “Purchase tickets to games in your area!” If a user selects advertisement 702 (e.g., with cursor 404), information customized based on the location of the computing device and the content being presented may be shown to the user.

Having thus described several aspects of at least one embodiment of this invention, it is to be appreciated that various alterations, modifications, and improvements will readily occur to those skilled in the art.

For example, though not illustrated, computing device 100 may include one or more non-SDR wireless network interfaces (not shown).

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computing device comprising a software defined radio, the computing device comprising:
configurable radio hardware;
at least one processor programmed to:
generate a user interface identifying one or more types of services;
receive, through the user interface, a user selection of a selected service of the one or more types of services; and
present, through the user interface, available options for the selected service;
a network interface for obtaining from a remote data store a radio profile to configure the radio hardware for the selected service and to obtain the available options for the selected service, the radio profile and the available options being based on a current location of the computing device; and
a controller for configuring the radio hardware with the radio profile for use at the current location.

2. The computing device of claim 1, wherein the radio profile is certified and the computing device is further configured to verify an authenticity of the radio profile prior to the controller configuring the radio hardware with the radio profile.

3. The computing device of claim 1, further comprising an audio output component and a display, wherein audio content is received from the selected service and is reproduced by the audio output component, and video content is received from the selected service is displayed on the display.

4. The computing device of claim 3, wherein:
the service selected by the user selection is a television service,
the available options include a plurality of television channels, and
the audio and video content is broadcast content corresponding a user selected television channel.

5. The computing device of claim 1, wherein the current location of the computing device is received as an entry from a user.

6. The computing device of claim 1, wherein the user interface component is further configured to receive user consent and when consent is provided, the user interface presents content customized based on the current location.

7. The computing device of claim 1, further comprising a location determining component for determining the current location of the computing device, wherein the location determining component identifies a prioritized location determining service among one or more location determining services and uses the prioritized location determining service to obtain the current location.

8. The computing device of claim 7, wherein:
the location determining component has a plurality of services for determining the current location, each service having a priority, and
the location determining service attempts to obtain the current location from the services in an order of descending priority until the current location is determined successfully.

9. The computing device of claim 7, wherein the one or more location determining services comprises at least one of:
a satellite navigation service for obtaining the current location from navigational satellites,
a network location service for determining the current location from a location on a network the computing device is currently connected to,
an beacon signal analyzing service for analyzing a beacon from a wireless network to identify a country code within said beacon,
a cellular base-station service, for determining the current location using cellular triangulation, and
a user interface service for obtaining the current location from the user through a user interface.

10. A method of presenting content on a computing device having a wireless network interface, the method comprising:
providing a user interface on the computing device identifying one or more types of wireless services;
receiving, through the user interface, a user selection of a selected service of the one or more types of wireless services;
presenting, through the user interface, available content for the selected service;
receiving, through the user interface, a user selection of a selected content from the available content;
sending a request for a communication profile to a remote data store, the request indicating the current location of the computing device;
receiving the requested communication profile from the remote data store;
configuring the computing device with the communication profile to extract the selected content from a signal received through the wireless network interface; and
presenting the content.

11. The method of claim 10, wherein:
the wireless network interface comprises a software defined radio,
the communication profile includes a radio profile, and
configuring the computing device comprises configuring the software defined radio with the radio profile.

12. The method of claim 10, further comprising:
identifying a prioritized location determining service among one or more location determining services and using the prioritized location determining service to obtain the current location,
wherein:
each of the one or more location determining services has a priority, and
identifying the prioritized location determining service comprises attempting to obtain the current location from the one or more location determining services in an order of descending priority until the current location is determined successfully.

13. The method of claim 10, wherein:
providing the user interface on the computing device identifying one or more types of wireless services comprises identifying a television service,
receiving a user selection of a selected content comprises receiving a user selection of a television channel, and
presenting the content comprises reproducing on a display video content of a television program and reproducing through a sound system audio content of the television program.

14. The method of claim 10, further comprising, determining the current location of the computing device using a wired network connection.

15. The method of claim 10, wherein determining the current location of the computing device using a wired network connection comprises inferring the current location based on a proximity on the network to another computing device having a known location.

16. A system for configuring a software defined radio, the system comprising:
a wireless client with the software defined radio, the wireless client further comprising:
a radio controller for configuring the software defined radio;
a location determining component for determining a current location of the wireless client; and
a first network interface for transmitting the current location; and
a remote server comprising:
a second network interface for receiving the current location from the wireless client;
a radio profile database; and
a database controller for querying the radio profile database and obtaining from the database a radio profile corresponding to the current location;
wherein:
the second network interface is configured to send the radio profile to the wireless client, the first network interface of the wireless client receiving the radio profile, and
the radio controller of the wireless client configures the software defined radio with the radio profile.

17. The system of claim 16, wherein:
the first network interface is further configured to transmit an identification of a wireless service,
the query provided from the database controller to the radio profile database comprises an the identification of the wireless service,
the radio profile obtained from the radio profile database by the database controller is for configuring the software defined radio to access the wireless service, and
the software defined radio, as configured by the radio controller with the radio profile, connects to the wireless service to receive content.

18. The system of claim 17, wherein the wireless service is a television service and the received content comprises a television program, the wireless client further comprising:
a display for displaying a video portion of the received content; and
at least one speaker for reproducing an audio portion of the received content;

19. The system of claim 16, wherein the location determining component identifies a prioritized location determining service among one or more location determining services and uses the prioritized location determining service to obtain the current location, the one or more location determining services comprising a satellite navigation service for obtaining the current location from navigational satellites.

20. The system of claim 16, wherein the radio profile comprises a certificate and the client device verifies the authenticity of the radio profile using at least the certificate.
